(19) United States
(12) Patent Application Publication
(10) Pub. No.: US 2002/0083835 A1
(43) Pub. Date: Jul. 4, 2002

(54) Smoke removing filter assembly for use with a candle

(76) Inventor: Paul Vibberts, Somers, CT (US)

Correspondence Address: ROBERT S. SMITH, LAW OFFICES OF ROBERT S. SMITH, SUITE 513, 57 PRATT STREET, HARTFORD, CT, 06103, US

(21) Appl. No.: 09/749,790

(22) Filed: Dec. 28, 2000

(51) Int. Cl. B01D 46/00

(52) U.S. Cl. 95/273; 55/385.1

(57) ABSTRACT

A filter assembly for use with an associated candle having an elongated wick which in normal operation is disposed vertically. The apparatus further includes a filter, the filter including means for extracting smoke from the emissions of the associated candle, and a housing. The housing includes means for supporting the filter above the associated candle whereby the filter assembly reduces emissions from the associated candle when the associated candle is burning. In some forms of the filter assembly the housing includes means for directing combustion products from the associated candle to the filter. In other forms of the invention the filter assembly the means for directing surrounds at least the sides of the highest axial extremity of the associated candle. The housing may be dimensioned and configured to extend completely around the highest extremity of the associated candle and in addition continue to a higher elevation to allow support of said filter assembly in spaced relationship to the associated candle. The housing, in some forms of the invention, has a substantially fluid tight wall that directs all gases rising from a flame burning at the wick at the highest axial extremity of the associated candle to the filter assembly.

### BACKGROUND OF THE INVENTION

The invention relates to candles used to provide light and ambiance. A wide variety of candles are sold through many distribution channels. Such candles include votive candles, jar candles, taper candles, classic candles and collenette candles, aroma therapy candles, and oil candles. They wide variety of available candle types and stores selling such candles either as a primary product or as part of a department store is indicative of the popularity of candles. The popularity of candles has grown despite and undesirable side effect of the use of candles. More particularly, the burning of candles produces a black sooty smoke. Regular burning of such candles causes the accumulation of dark spots on the ceiling above the location where the candle is routinely burned. In addition, the cumulative effect will also cause discoloration on other room surfaces such as walls. Over long periods of time the accumulated soot is very objectionable.

### SUMMARY OF THE INVENTION

It is an object of the present invention to provide apparatus which will limit the effects on the ceiling and walls of the room in which the candles are burned as well as limiting the effects on other surfaces in the room in which the candles are burned.

Another object of the invention is to provide such apparatus that can, in some embodiments, be retrofitted onto existing candle holder apparatus.

It is also an object of the invention to provide apparatus which is a complete assembly for holding a candle while it is burning as opposed to the embodiments of the present invention which are intended to be retrofitted onto existing candle holder apparatus.

Still another object of the invention is to provide apparatus which is easy to utilize.

Yet another object of the invention is to provide apparatus which is easy and inexpensive to manufacture.

It has now been found that the easy and other objects of the invention may be attained in a filter assembly for use with an associated candle having an elongated wick, which in normal operation is disposed vertically. The apparatus further includes a filter, The filter includes means for extracting smoke from the emissions of the associated candle, and a housing. The housing may include means for supporting the filter above the associated candle whereby the filter assembly reduces emissions from the associated candle when the associated candle is burning..

In some forms of the filter assembly the housing includes means for directing combustion products from the associated candle to the filter. In some forms of the invention the means for directing surrounds at least the sides of the highest axial extremity of the associated candle.

The housing may be dimensioned and configured to extend completely around the highest extremity of the associated candle and in addition continue to a higher elevation to allow support of said filter assembly in spaced relationship to the associated candle. The housing, in some forms of the invention, has a substantially fluid tight wall that directs all gases rising from a flame burning at the wick at the highest axial extremity of the associated candle to the filter assembly.

The filter assembly may be manufactured at least in part, from synthetic resins, such as Polyphenylene Sulfide having a permeability of at least 40 CFM in which is thermally stable for two hours at 400 degrees Fahrenheit.

### BRIEF DESCRIPTION OF THE DRAWING

The invention will be better understood by reference to the accompanying drawing in which:

FIG. 1 is a partially sectional elevation view of one form of the apparatus in accordance with the present invention.

FIG. 2 is a fragmentary elevation view illustrating in greater detail a portion of the shade shown in FIG. 1.

FIG. 3 is a fragmentary elevation view illustrating in greater detail a support shown in FIG. 1.

FIG. 4 is a plan view illustrating in greater detail the support for a filter that is also shown in FIG. 1.

FIG. 5 is a partially sectional view I'II another embodiment of the apparatus in accordance with the present invention in which the “shade” rests directly on the upper rim of an associated jar candle.

FIG. 6 is a partially sectional view of a third embodiment having a ceramic body.

### DESCRIPTION OF THE PREFERRED EMBODIMENTS

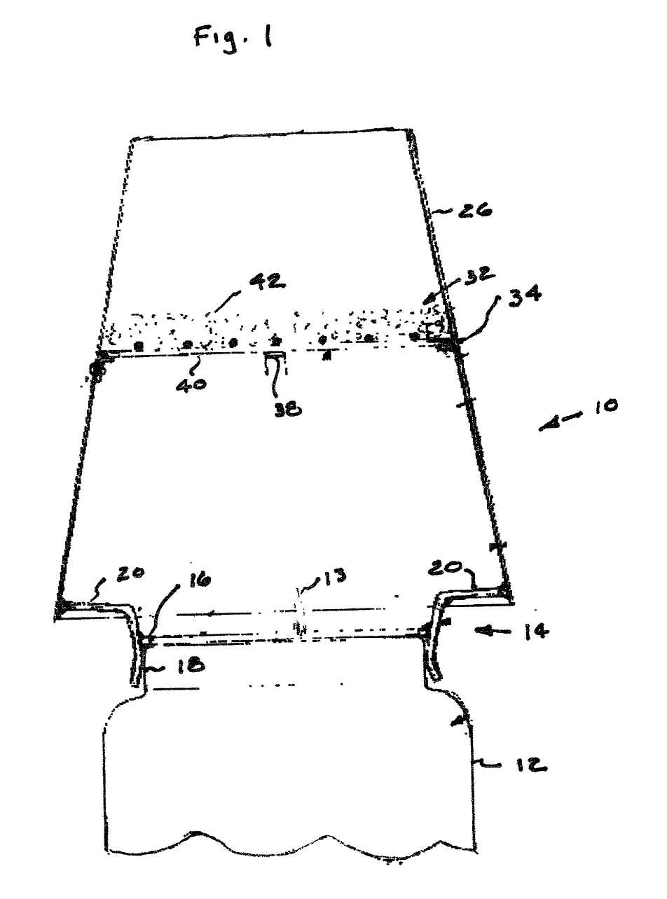

Referring now to FIGS. 1-4 there is shown a first embodiment of the present invention. The illustrated candle and shade assembly 10 includes a conventional jar candle 12. The conventional jar candle is a jar in which a candle having a wick 13 is disposed. Carried on the jar candle 12 is a ring and strut assembly 14 that includes a ring 16 having approximately the same outer diameter as the neck 18 of the jar candle 12.

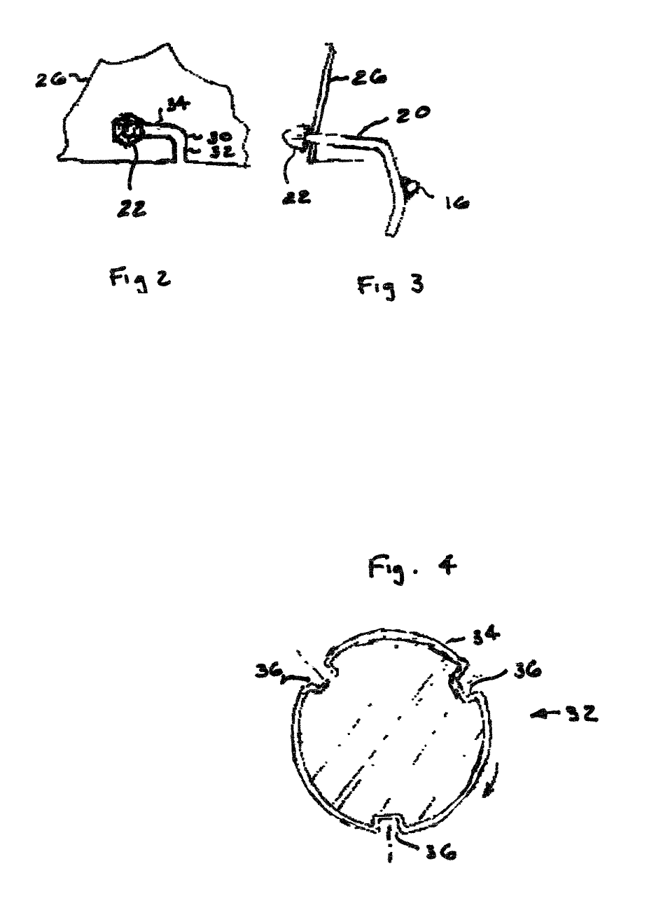

Disposed typically at equal angular positions about the circumference of the ring 16 are generally L-shaped struts 20. Typically three or four such struts 20 are welded to the ring 16. Each struct 20 has a generally vertical leg that is welded to the rim 16 and a generally horizontal leg that extends generally horizontally when the ring and strut assembly 14 is installed on a jar candle 12 in its normal operating position. Each strut 20 has an acorn nut 22 fixed to the extremity of the horizontal portion as best seen in FIGS. 2 and 3.

A metal truncated cone shaped shade 26 is carried by the ring and strut assembly 14. The shade 26 is opening at the top to allow free passage of combustion products. Similarly, air can flow into the bottom part of the shade 26 since the three or four struts 20 do not materially affect the flow of the air upwardly. It will be understood that the flow of air is ordinarily upward since the combustion at the wick 13 will heat the air within the shade 26 and thus decrease the density of the air causing it to rise in the room in which the candle and shade assembly 10 is disposed. As best seen in FIGS. 2 and 3 the shade 26 has an L-shaped slot 30 cut in the lower most extremity of the shade 26. Each slot as a vertical portion 32 extending to the lower most edge (as viewed) of the shade 26. Extending from the vertical portion 32 of the slot 30 is a horizontal portion 34.

Each of the slots 30 is disposed in registered relationship to one of the struts 20. Accordingly those skilled in the art will recognize that the shade 26 is affixed to the ring and strut assembly 14 by inserting each of the struts 20 into the vertical portion 32 of one of the slots 30. Thereafter, the shade 26 is lowered until the respective struts 20 enter the horizontal portion 34 of the slots 30. Thereafter the shade 26 is rotated counter-clockwise (as viewed from the top) until the respective struts are disposed at the end of the horizontal portion 34 of the respective slots 30. This position is illustrated in FIG. 2. The respective acorn nuts 22 prevent movement of the shade 26 walls of the strut 26 and in addition provide a smooth exterior surface that might otherwise catch on clothing or even be injurious to the user of the apparatus.

Referring specifically to FIG. 4 there is shown a filter assembly 32 that includes a carrier 34 that is a metallic ring shaped body having a generally circular circumference. In the generally circular circumference of the ring shaped body are three recesses 36, 36, 36. The recesses 36, 36, 36 are spaced at equal angular positions about the circumference of the body of the carrier 34. In the preferred embodiment the shade 26 has fingers 38 stamped out of the face of the shade 26. Each finger 38 is a substantially planar part of the “skin” of the shade 26 and is generally horizontal. Each fingers 38 is dimensioned and configured for cooperation with one of the recesses 36.

It will thus be seen that the filter assembly 32 may be installed by removing the shade 26 from the struts 20, 20, 20 and inserting the filter assembly 32 into the large end of the shade 26. The filter assembly 32 is rotated about the geometric axis thereof so that the recesses 36 are aligned with the fingers 38. When alignment is attained the filter assembly 32 is pushed above the fingers 38. Thereafter, the filter assembly 32 is rotated so that the recesses 36 are not aligned with the fingers 38. Accordingly, the fingers 38 will then support the filter assembly 32 and prevent passage of the filter assembly back towards the jar candle 12.

The carrier 34 has any porous lattice support 40 extending intermediate the inner circular sides of the ring shaped body of the carrier 34. This support 40 will hold a filter material 42. The filter material 42 used will vary for specific applications, however, a preferred material is manufactured by Tex Tech Industries having a corporate headquarters at Portland, Me. and a World Wide Web URL of www.textechindustries.com. The material is identified by the style member 230BR. This filter material is Polyphenylene Sulfide and is marketed under the trademark TORCON by Kabushiki Kaisha TA Toray Industries, Inc. CORPORATION JAPAN 2-1, 2-chome, Nihonbashi-Muromachi Chuo-ku, Tokyo JAPAN. The construction is a 2×2 twill weave having a weight of 10-12 ounces per square yard, a count of 43 EPI×31 PPI, a tensile strength MD 275 lbs. per four inch grab and CMD 250 lbs. per four inch grab and a mullen of 380 P.S. I, a permeability of 40-55 CFM, a thermal stability of two hours at 400 degrees F. with a MD of 3.0 percent maximum and a CMD of 3.0 percent maximum.

These filter materials have been found to remove a substantial part of the smoke emitted by a burning candle and thus prevents the accumulation of soot on the ceiling and walls and other surfaces in a home that would otherwise be subject to such contamination in the absence of the apparatus in accordance with the present invention. Although the above describes only one such mechanism for supporting the filter media or the burning candle, those skilled in the art will recognize that a wide variety of other apparatus may be provided to support the filter media.

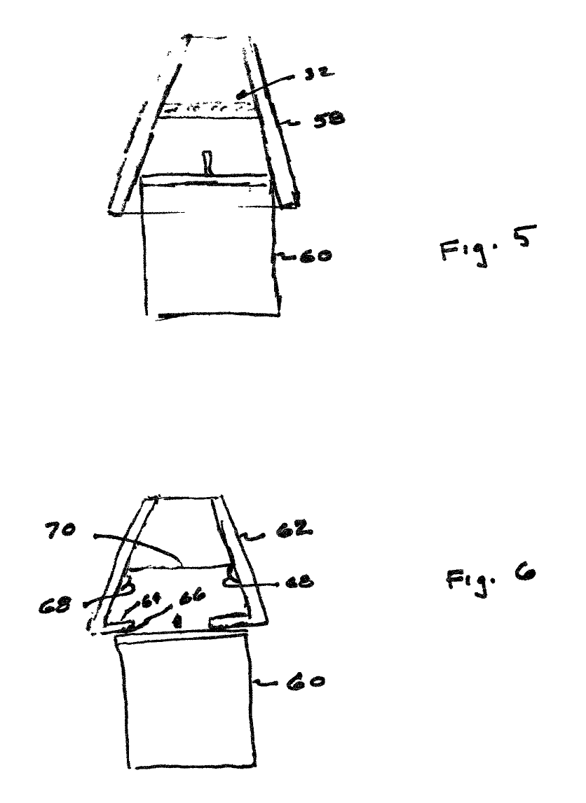

Examples of other structures with may also be employed to support a filter media include those shown in FIG. 5-6. In the embodiment of FIG. 5 a truncated conical shade 58 is dimensioned to rest on the upper circular surface of a jar candle 16. In such embodiment the filter media may be the same filter assembly 32 as that shown in FIGS. 1-4. Similar fingers to the these fingers 38 shown in FIG. 1 may also be used in the embodiment of FIG. 5.

The embodiment of FIG. 6 illustrates an embodiment incorporating a jar candle 16 of the type shown in FIG. 5. A ceramic shade 62 as a generally truncated, cool shape and further includes a horizontal extending flange. A lip 66 disposed on the inner edge of the flange 64 registers with the top of the jar candle 60 to prevent the lateral motion of the shade 62. In such an embodiment the opening at the bottom of the shade is substantially the same as the opening at the top of the shade 62. Both of these openings are smaller than the required size for the filter media. In such an embodiment the shade may be manufactured with shoulders 68 at a number of angular locations about the inner surface of the shade 62. The filter media 70 may be chosen to be sufficiently flexible to bend to allow insertion within the shade 62 and sufficiently stiff to insure that the media when placed on the shoulders 68 will have sufficient retention to maintain its position on the shoulders 68.

Having thus described my invention, those skilled in the art will recognize other embodiments which may be constructed. Accordingly it is intended that this invention be limited only by the claims which follow:

1. A filter assembly, for use with an associated candle having an elongated wick which in normal operation is disposed vertically, which comprises:
a filter, said filter including means for extracting smoke from the emissions of the associated candle, and
a housing, said housing including means for supporting said filter above the associated candle whereby said filter assembly reduces emissions from the associated candle when the associated candle is burning.

2. A filter assembly as described in claim 1, wherein:
said housing includes means for directing combustion products from the associated candle to said filter.

3. The filter assembly as described in claim 2 wherein
said means for directing surrounds at least the sides of the highest axial extremity of the associated candle.

4. A filter assembly as described in claim 3, wherein:
said housing is dimensioned and configured to extend completely around the highest extremity of the associated candle and in addition continues to a higher elevation to said filter.

5. A filter assembly as described in claim 4, wherein:
said housing has a substantially fluid tight wall that directs all gases rising from a flame burning at the wick at the highest axial extremity of the associated candle to said filter.

6. A filter assembly as described in claim 1, wherein:
said filter assembly is manufactured, and least in part, from synthetic resins.

7. A filter assembly as described in claim 6, wherein:
said filter assembly is manufactured, at least in part, from a material manufactured from Polyphenylene Sulfide.

8. A filter assembly as described in claim 6, wherein:
said filter assembly is manufactured, at least in part, from a material having a permeability of at least 40 CFM.

9. A filter assembly as described in claim 6, wherein:
said filter assembly is manufactured, at least in part, from a material that it is thermally stable for two hours at 400 degrees Fahrenheit.

10. A filter assembly as described in claim 2, wherein:
said filter assembly is manufactured, at least in part, from synthetic resins.

11. A filter assembly as described in claim 3, wherein:
said filter assembly is manufactured, at least in part, from synthetic resins.

12. A filter assembly as described in claim 4, wherein:
said filter assembly is manufactured, at least in part, from synthetic resins.

13. A filter assembly as described in claim 5, wherein:
said filter assembly is manufactured, at least in part, from synthetic resins.

14. A filter assembly as described in claim 6, wherein:
said filter assembly is manufactured, and least in part, from synthetic resins.

15. A filter assembly as described in claim 1, wherein:
said filter assembly is manufactured, at least in part, from a material manufactured from Polyphenylene Sulfide.

16. A filter assembly as described in claim 15, wherein:
said filter assembly is manufactured, at least in part, from a material having a permeability of at least 40 CFM.

17. A filter assembly as described in claim 16, wherein:
said filter assembly is manufactured, at least in part, from a material that it is thermally stable for two hours at 400 degrees Fahrenheit.

18. A filter assembly as described in claim 2, wherein:
said filter assembly is manufactured, at least in part, from a material manufactured from Polyphenylene Sulfide.

19. A filter assembly as described in claim 3, wherein:
said filter assembly is manufactured, at least in part, from a material manufactured from Polyphenylene Sulfide.

20. A filter assembly as described in claim 4, wherein:
said filter assembly is manufactured, at least in part, from a material manufactured from Polyphenylene Sulfide.
